(19) United States
(12) Patent Application Publication
(10) Pub. No.: US 2023/0313817 A1
(43) Pub. Date: Oct. 5, 2023

(54) DEPTH COMPENSATED ACCUMULATOR SYSTEM FOR GENERATION OF HYDRAULIC POWER TO SUBSEA OPERATIONS

(71) Applicant: OBS Technology AS, Husøysund (NO)

(72) Inventor: Nils Terje OTTESTAD, Husøysund (NO)

(21) Appl. No.: 18/016,146

(22) PCT Filed: Mar. 9, 2021
(86) PCT No.: PCT/NO2021/000001

§ 371 Date: Jan. 13, 2023

(30) Foreign Application Priority Data
Mar. 13, 2020 (NO) 20200308

(51) Int. Cl. F15B 1/04; F15B 1/26

(52) U.S. Cl. CPC F15B 1/04; F15B 1/26; E21B 33/0355

(57) ABSTRACT

The invention relates to an underwater-based, depth-compensable accumulator system which is adapted to produce hydraulic power for underwater operations, and which consists of one or more gas-free accumulator units. An accumulator unit according to the invention has only one movable part, but interaction with a switching device enables switching between multiple modes so that an accumulator unit can be configured to generate a desired hydraulic pressure at any sea depth.

### TECHNICAL FIELD OF THE INVENTION

The invention relates to an underwater-based, depth-compensable accumulator system which is adapted to produce hydraulic power for underwater operations, and which consists of one or more gas-free accumulator units. An accumulator unit according to the invention has only one movable part, but interaction with a switching device enables switching between multiple modes so that an accumulator unit can be configured to generate a desired hydraulic pressure at any sea depth.

### BACKGROUND OF THE INVENTION

Future oil extraction will take place from installations at even greater depths, and a prerequisite for safe operation of such installations is that at all times there is an almost immediate access to a significant amount of hydraulic power. Compared with hydraulic systems based on compressed gas, an accumulator system according to the invention will be able to deliver significantly larger amounts of hydraulic power in relation to weight / size. A significant operational advantage is also obtained in that the system with simple operations can be configured for a radical change of depth without having to be pulled up to the surface.

An accumulator system according to the invention is particularly suitable for generating hydraulic energy for operation of work-over completion systems. These systems are used to overhaul oil wells that can be located at any water depth.

### KNOWN TECHNIQUE

Various valve devices and actuators used in subsea-based oil operations are to a large extent operated by means of hydraulic pressure, the material being arranged to utilize the overpressure of the hydraulic fluid relative to ambient pressure. Today, the hydraulic force is preferably generated by transferring the pressure of a compressed gas to the hydraulic fluid via a displaceable piston which acts as a barrier between the compressed gas and the hydraulic fluid. Gas compressed to very high pressures lose pressure rapidly upon expansion, and consequently has a limited ability to transfer energy. This ability is further impaired by thermal effects that create a temperature drop that results in a reduction in the transfer pressure.

To get more energy out of gas accumulators, depth-compensated accumulators have been developed in which there are established forces that zero out the effect of a changed ambient pressure. This is achieved by means of a piston arrangement where two oppositely directed surfaces sense resp. ambient pressure resp. an approximate zero pressure in a gas cylinder. This solution requires expensive machining and will not prevent the gas pressure from reaching a pressure level where its compressibility is significantly reduced compared to an ideal gas. This is because some equipment require a hydraulic pressure of 345 bar and higher.

NO 20190053 A1, WO 2018/160071 A1, WO 2016/133400 A1 and US 2013/0074687 A1 refer to known technology which is relevant in relation to the present invention. This technology is based on accumulators that generate hydraulic power by means of displaceable pistons and utilize to varying degrees the pressure difference between ambient water pressure and low-pressure liquid-free chambers. NO 20190053 A1, WO 2018/160071 is, like the present invention, based on energy being stored by establishing an approximate gas and liquid-free volume in tanks or accumulators at depths, and that energy stored in this way is converted into hydraulic energy by utilizing the pressure of liquid which is returned to this volume via pressure-sensitive piston devices.

NO20190053 has the greatest similarities with the present invention in that it is based on completely gas-free accumulators in cooperation with pressure stabilizing valves which ensure that the accumulators can be set for a fixed hydraulic pressure which will be maintained even if the accumulators are moved to a substantially changed depth.

A constructional feature which particularly distinguishes the present invention from the prior art is that it comprises a switching device which is arranged to cooperate with a displaceable piston device so that various operating modes are established, each representing an altered relationship between the pressure of the propellant and the hydraulic pressure produced by the accumulator units. The switching device in question can thus be switched between a large number of operating modes, and as a result an accumulator system can be assembled by accumulator units which individually can utilize the energy in a supplied propellant efficiently to deliver hydraulic energy that maintains a preset pressure level at any sea depth.

### BRIEF DESCRIPTION OF THE DRAWINGS

The operation of the accumulator units and an accumulator system according to the invention is described in the following with reference to FIGS. 1-6, where

FIG. 1 shows a principle sketch of a simplified first embodiment of an accumulator system according to the invention.

FIG. 2 shows a principle sketch of an accumulator unit consisting of three separate chambers

FIG. 3 shows a principle sketch of a 6-chamber accumulator unit with a simple switching device

FIG. 4 shows a view of relevant embodiments of the piston device

FIG. 5 shows a view of a preferred embodiment of a pressure stabilizing valve

FIG. 6 shows an almost complete accumulator system according to the invention

### DETAILED DESCRIPTION OF THE INVENTION

Subsea based hydraulic equipment has a nominal operating pressure which can typically be 345 bar above ambient water pressure. The accumulator system in question can be used to generate any relevant hydraulic pressure, but for simplicity the further description is based on 345 bar delivery pressure.

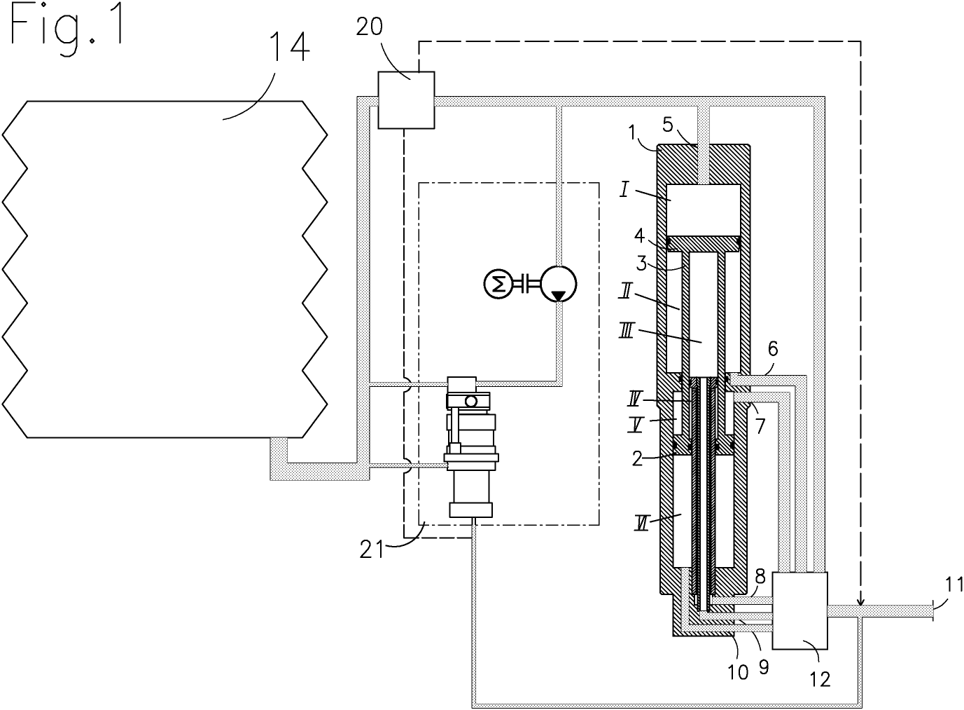

FIG. 1 shows a view of a simplified hydraulic system comprising an accumulator unit with 6 internal chambers. The propellant is stored in a flexible reservoir 14) and thereby has approximately the same pressure as the surrounding water. The accumulator unit consists of an accumulator housing 1) with an axially displaceable piston device 2-4) which separates 6 chambers (I - VI) with separate connections to 6 ports 5-10) in the accumulator housing. Chamber I is in contact with the largest pressure surface of the piston arrangement, and is referred to as a drive chamber, this chamber being in permanent open connection with the drive medium via the inlet port 5). In principle, the drive chamber is the only chamber which, regardless of the operating mode, is in open connection with the drive medium. At least one of the remaining five chambers is virtually depressurized, while the remaining are filled with liquid and are placed in open connection with either the inlet port 5) or with the outlet port 11) which is arranged on said switching device 12).

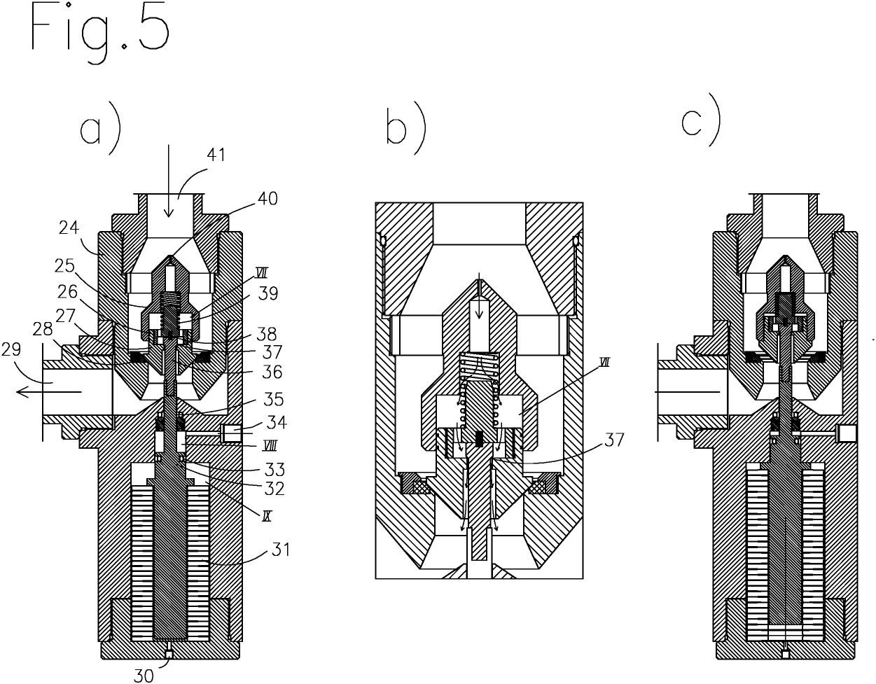

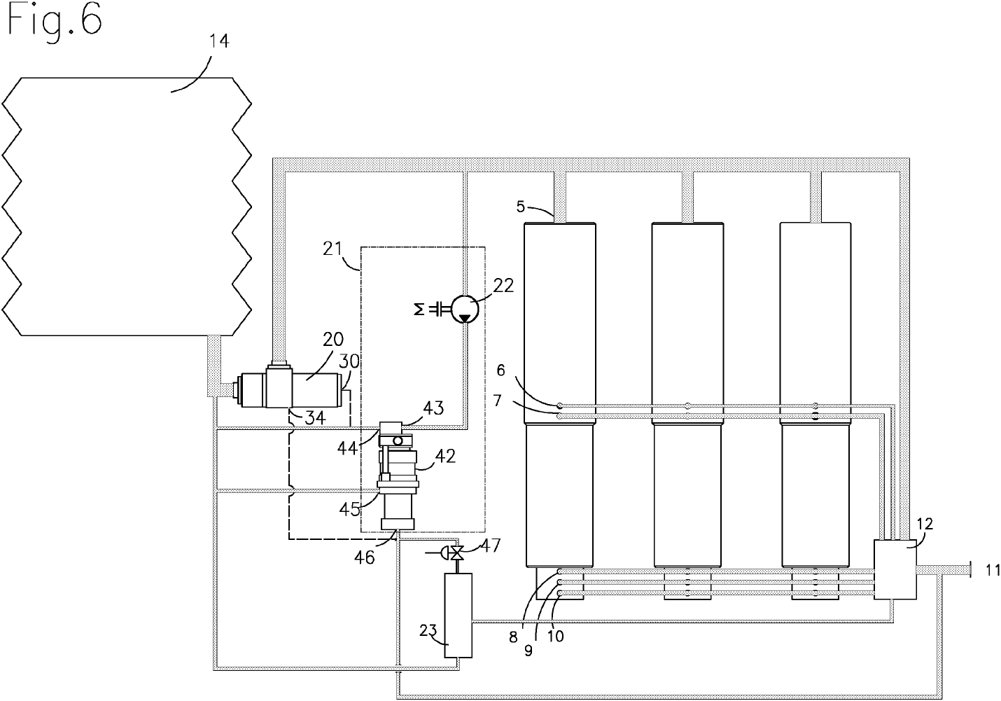

The accumulator system will normally comprise a pressure stabilizing valve 20) which is arranged between said reservoir and the accumulator unit(s) and is arranged to regulate the supply of propellant medium to the accumulator unit(s) so that the hydraulic pressure maintains the desired level regardless of mode. Such a pressure stabilizing valve can be omitted if the accumulator unit is to be used within a limited depth range, since with the use of 6 chambers it will be possible to keep the hydraulic pressure within, for example, 345 bar +/- 10%. The operation of a preferred embodiment of a pressure stabilizing valve will be explained later with reference to FIG. 5. The hydraulic system will normally comprise a charging device 21) for maintaining hydraulic capacity. This preferably comprises an electrically driven low pressure pump and a pressure boosting pump. The operation of the charging device will be explained later with reference to FIG. 6.

### Operation of Gas-Free Accumulator

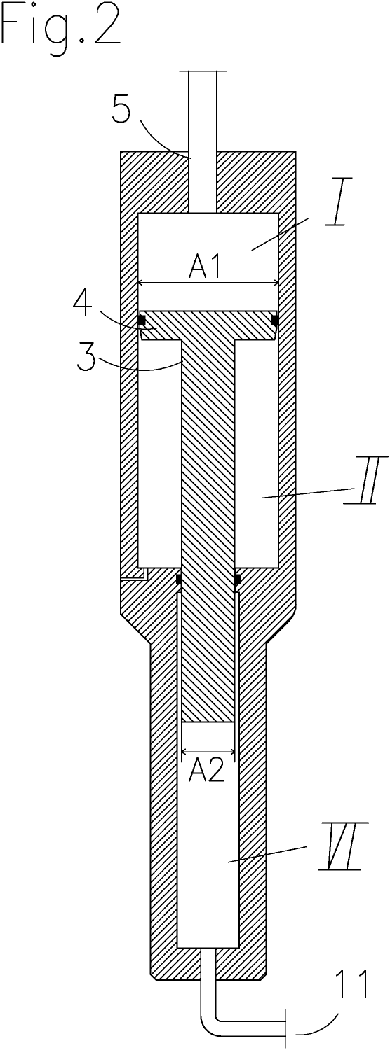

The operation of a gas-free accumulator unit is explained with reference to FIG. 2 which is showing a view of an accumulator unit with a piston device 3,4) that separates three separate chambers (I, II, VI) in the accumulator housing 1). The housing has an inlet port 5) for supplying a propellant, and an outlet port 11) for dispensing pressurized hydraulic fluid. The piston device is composed of a piston rod 3) with cross section A2 and a piston 4) with pressure surface A1 that cooperates with two sliding seals 2,5) which prevent leakage between the three chambers (I, II, VI).

Chamber I is referred to as a drive chamber and has contact with the largest pressure surface of the piston device and with the inlet port 5). The propellant is introduced into the propellant chamber I with a pressure P_{D} ≤ P_{AMB}, where P_{AMB} is defined as ambient water pressure. The drive medium will consequently create a force Fs = P_{D} * A1 against the piston device. This force seeks to push the piston device in the direction away from the inlet 5) and generates correspondingly large counterforces in the chambers I and II. The counter force from chamber II is negligible because this the chamber is arranged to be virtually without pressure. This is preferably achieved in that the port 6) is blinded off after the piston device has been pressed up against the position where the volume of chamber I is almost zero. The friction in the sliding seals 15,16) is considered insignificant in this context, so that Fs can almost fully be used to pressurize the hydraulic fluid in chamber Vl. The force balance of the axial forces acting on the piston device is thus given by;

$${\text{P}}_{\text{D}} * \text{A1} = \text{PH} * \text{A2} = {\text{F}}_{\text{S}} \text{or PH} = \text{A1} / \text{A2} * {\text{P}}_{\text{D}} \qquad \text{1)}$$

where PH is the absolute pressure of the hydraulic fluid

We define the gain factor K of the accumulator unit as the ratio between the hydraulic pressure PH generated and the drive pressure PD being generated. Of which; K = PH / P_{D},

Equation 1) shows that the gain factor for the accumulator unit in question is K = A1 / A2. Equation 1 can thereby be transformed into;

$$\text{PH} = {\text{P}}_{\text{H}} + {\text{P}}_{\text{D}} = {\text{P}}_{\text{D}} * \text{K or} \qquad \text{2)}$$

$${\text{P}}_{\text{H}} = \text{K} * {\text{P}}_{\text{D}} - {\text{P}}_{\text{AMB}}$$

where PH is the overpressure of the hydraulic fluid in relation to the ambient water pressure

In the following calculation example, we assume that this accumulator unit shall be arranged at a depth of 500 meters, and that it shall be able to operate hydraulic equipment with a nominal operating pressure of 345 bar. We want the accumulator unit to generate a hydraulic pressure of 345 bar at a depth of 500 meters.

The further calculations are simplified by the atmospheric pressure being set equal to 1 bara = 1 kp / cm2, and by the pressure increase per 10 meters water depth being set equal to 1 bar. In these calculations, the friction of the sealing rings is considered negligible.

If an accumulator unit with a gain factor of 7.76 is lowered to, for example, 800 msw, P_{D} = P_{AMB} will produce an absolute hydraulic pressure PH = 81 * 7.76 bara = 628.5 bara - which corresponds to 547.5 bar above P_{AMB}. We thus see that the prerequisite for being able to rely on this type of accumulator units at great depths is dependent on a pressure-reducing valve that lowers the propellant pressure down to a level that is in part significantly lower than P_{AMB}. As an example, the propellant pressure must be lowered from P_{AMB} = 101 bar to P_{D} = 57.5 bar if the hydraulic pressure is to remain 345 bar (above P_{AMB}) at 1000 msw. This is not beneficial for two reasons. One is that having to lower the drive pressure significantly in relation to P_{AMB} represents an undesirably large loss of energy, and the other is that a large pressure drop puts greater stresses on the pressure regulating valve which is supposed to maintain a stable hydraulic pressure.

### Operation and Properties of a Hydraulic System According to the Invention

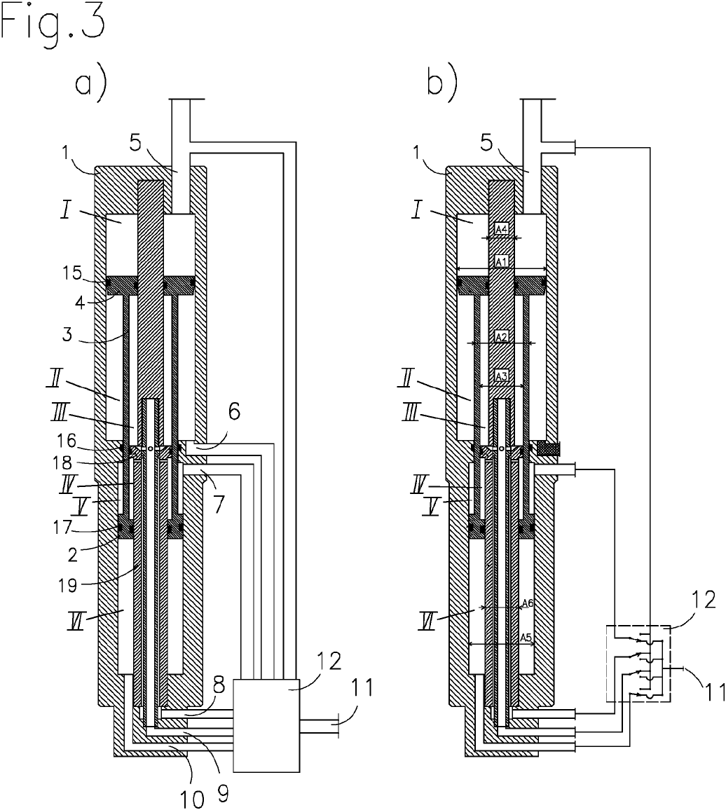

An accumulator unit according to the invention is based on the displaceable piston device being designed so that preferably 6 chambers are delimited, all these chambers - with the exception of the drive chamber I - can in principle be switched between three states where they are either depressurized, placed in open connection with the port 5) which in the following description is referred to as the inlet port, or is put in open connection with the outlet port 11) which delivers pressurized hydraulic fluid. For a further description of the invention, reference is made to FIG. 3 showing an enlarged view of a 6-chamber accumulator unit (I-VI).

The piston device 2,3,4) consists of a hollow piston rod 3) and two pistons 2,4). The cavity is cylindrical, is arranged axially in the piston rod and is cooperating with a rod 19) which is fixedly mounted to the housing 1). The rod 19) has a cylindrical outgrowth 18) which is mounted on a sliding seal so that the cavity is separated leak-free into two chambers III, IV). The piston device in this embodiment separates 6 separate chambers, of which 4 chambers (I, II, V, VI) have contact with pressure areas on the outside of the piston device, and 2 chambers (III, IV) have contact with pressure areas on the inside of the piston arrangement. All chambers have a separate open connection to one of the 6 ports 5-10) in the accumulator housing, and from these ports there are pipe connections to the switching device 12) which is arranged to produce any desired connection of the chambers. Three of the chambers (II, III, VI) have contact with pressure areas facing away from the inlet port 5), and pressurization of these chambers produces forces which seek to push the piston device away from the inlet port. Similarly, three of the chambers (I, IV, V) are in contact with pressure areas on the piston arrangement which are directed towards the inlet port 5), and pressurization of these chambers produces forces which seek to push the piston arrangement in the direction of the inlet port 5).

The pressure areas for the 6 chambers (I-IV) are denoted A_{I} - A_{VI} and are defined by the circular cross-sections A1 - A5 as follows;

$$\begin{matrix}{\text{A}}_{\text{I}} = {\text{A1, A}}_{\text{II}} = {\text{A1-A2, A}}_{\text{III}} = {\text{A3, A}}_{\text{IV}} = \text{A3-A4,} \\ {\text{A}}_{\text{V}} = {\text{A5-A2, A}}_{\text{VI}} = \text{A5-A4}\end{matrix}$$

Similarly, the pressure in the six chambers is referred to as P_{I}, P_{II}, P_{III}, P_{IV}, P_{V} and P_{VI}. Since the forces which affect the piston arrangement in the axial direction must be in equilibrium, the following equilibrium equation can be set up based on absolute pressure;

$${\text{P}}_{\text{I}} * {\text{A}}_{\text{I}} + {\text{P}}_{\text{IV}} * {\text{A}}_{\text{IV}} + {\text{P}}_{\text{V}} * {\text{A}}_{\text{V}} = {\text{P}}_{\text{II}} * {\text{A}}_{\text{II}} + {\text{P}}_{\text{III}} * {\text{A}}_{\text{III}} + {\text{P}}_{\text{VI}} * {\text{A}}_{\text{VI}} \qquad \text{3)}$$

Chamber I is a drive chamber, and will always have the pressure P_{D}, while the other 5 chambers can in principle alternate between resp. to be depressurized, to be connected to the inlet port 5) or to be connected to the outlet port 11) for the hydraulic fluid.

There are a large number of coupling options for the five chambers II-VI, but the following conditions must be met for the accumulator unit to be able to generate hydraulic energy;
The chamber that is in contact with the largest pressure area on the piston arrangement must function as a drive chamber and have an open connection to the drive fluid
At least one of the chambers in contact with a pressure surface that is oppositely directed by the largest pressure surface on the piston arrangement must have low pressure (be virtually pressureless).
At least one of the chambers which are in contact with a pressure surface which is opposite to the largest pressure surface on the piston arrangement must have an open connection to the outlet port 11).

Mode of operation for a gas-free accumulator unit with 6 chambers is in principle the same as for an accumulator with three chambers. The difference is that the establishment of six chambers provides many combination possibilities, both in terms of the magnitude of the resultant force which the pressure of the propellant produces against the piston device in the direction away from the inlet port 5) and in terms of the size and direction of the areas that utilize the transmitted force to pressurize the hydraulic fluid. The modes generated, represented by each of the selected coupling setups, will all be able to provide an efficient transfer of energy from the propellant to the hydraulic fluid. The ratio between the amount of propellant supplied and the amount of hydraulic fluid discharged is unambiguously determined by the selected gain factor. It is thus desirable to find a set of modes which combine large uptake of propellant with gain factors which enable the individual accumulator unit to be able to operate the individual accumulator unit over a range of the widest possible depth range. This is illustrated by Table 1 and Table 2 which show the properties of an accumulator unit with an embodiment in accordance with the view of the accumulator unit shown in FIG. 3. The following mutual dimensioning has been chosen;

$$\begin{matrix}\text{A2 = 0} \text{.37 * A1} \text{A3 = 0} \text{.23 * A1} \text{A4 = 0} \text{.082 * A1} \\ \text{A5 = 0} \text{.54} \text{A6 = 0} \text{.14 * A1}\end{matrix}$$

The tables are based on only a small part of possible combinations since chamber II is kept pressureless in all modes, chambers III, IV and VI is only altered between being connected to the inlet port 5) or the outlet port 11), and chamber VI is only altered between being connected against the outlet port 11) or being pressureless. To achieve these combinations 4 two-way valves are required, thereby providing 2⁴ = 16 optional connections. Of these 16 coupling alternatives, 10 coupling options are usable for the purpose, while the remaining 6 are not fit for generation of hydraulic power. In Table 1 and Table 2, we have selected the 7 connection alternatives that are considered most suitable under the given conditions.

The rubric “Volume” indicates how many liters of hydraulic fluid with P_{H} = 345 bar that can be emitted in the respective modes for an accumulator unit that has a stroke length of 100 cm and where A1 is chosen equal to 314 cm² (corresponding to 0̸ = 200 mm). We see that the accumulator unit can deliver 4.7 liters with the switching option which gives a gain factor = 7.8. This is about 18% more than can be achieved with a three-chamber accumulator unit with the same gain and the same piston diameter and stroke. The reason for this increased utilization is that chambers IV and V contribute to increased utilization of the propellant.

TABLE I

| | | | | | | | |
|---|---|---|---|---|---|---|---|
| F= | 7.8 | 4.97 | 3.76 | 3.2 | 2.72 | 2.37 | 2.14 |
| P_{AMB} | IV,V | III,IV | III,IV | | III,IV,V | V | IV,V |
| P_{H} | III | V | V,VI | III,IV,V,VI | VI | III,IV,VI I | III,VI |
| VOID | II,VI | II,VI | II | II | II | II | II |
| Volume | 4.7 | 7.4 | 7.12 | 8.95 | 11.8 | 14.4 | 17.2 |

Table 2 shows the maximum and the minimum depth. Minimum depth is defined as the depth at which P_{D} = P_{AMB} produces P_{H} = 345 bar. Maximum depth is defined as the depth at which the gain factor specified in the next column produces P_{H} = 345 bar when P_{D} is set equal to P_{AMB}.

The largest ΔP value indicates the pressure drop that the pressure stabilizing valve must produce at the “greatest depth” to maintain P_{H} = 345 bar.

Table 2 shows that an accumulator unit according to the given dimensioning will be able to produce a desired hydraulic pressure from typically 500 msw to just over 4000 msw by means of a switching arrangement based on four two-way valves.

TABLE 2

| | | | | | | | |
|---|---|---|---|---|---|---|---|
| Amplification factor | 7.8 | 4.97 | 3.76 | 3.2 | 2.72 | 2.37 | 2.14 |
| Minimum depth (msw) | 500 | 859 | 1240 | 1588 | 1996 | 2508 | 3016 |
| Maximum depth (msw) | 859 | 1240 | 1588 | 1996 | 2508 | 3016 | 4000 |
| Largest ΔP (bar) | 18.7 | 30.4 | 27 | 30 | 32.3 | 25.1 | 52.3 |

In FIG. 3, the mutual dimensioning in the shown views of accumulator units with 6 chambers is in accordance with the data given in Tables 1 and 2.

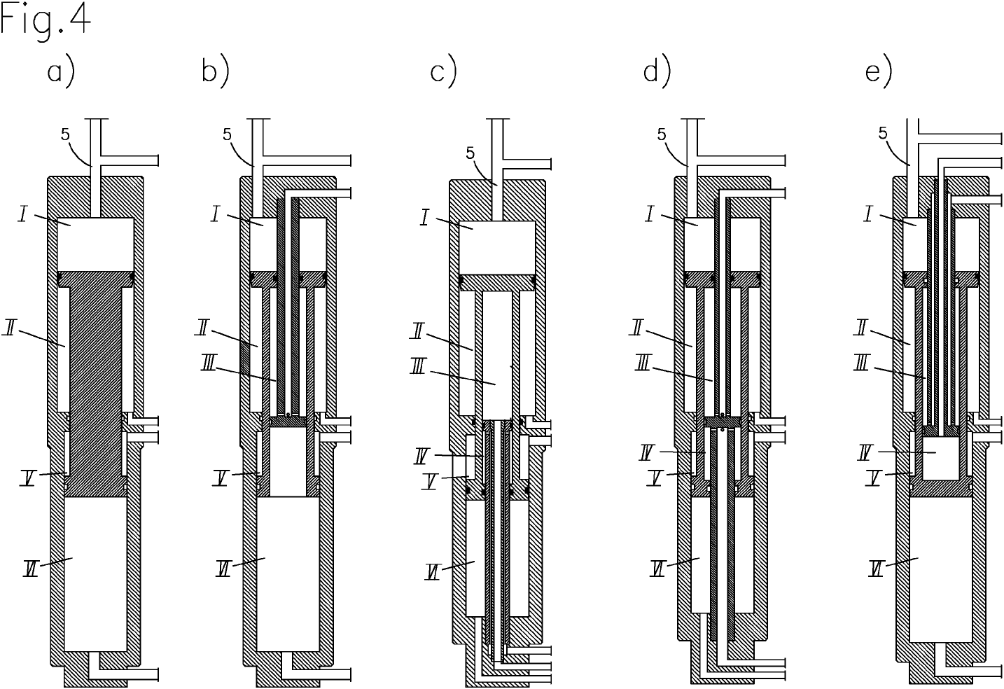

FIGS. 4 a-e) shows alternative embodiments with respect to piston device 2-4) and rod 19) with outgrowth 18). FIG. 4a) shows an embodiment with 4 chambers. FIG. 4b) and 4c) show embodiments based on 5 chambers. FIG. d) and e) show embodiments based on 6 chambers. The choice of design is selected based on how the accumulator system should work. If it is to be used in work-over systems, one will normally choose a 6-chamber solution to be able to produce a desired hydraulic pressure over a large depth range. If the hydraulic system is to be used for the operation of a BOP, a four-or five-chamber solution may be more advantageous.

### The Function of a Pressure Stabilizing Valve According to the Invention

FIGS. 5 a-c show different views of a pressure stabilizing valve in the preferred embodiment. The valve comprises a housing 24) with an inlet 41) and an outlet 29) and is arranged to control the supply of drive medium to the inlet port 5) of the accumulator unit by displacing an axially arranged first valve body 27) relative to an annular seat surface 28 - thereby changing the flow cross-section through the valve. The displacement of the valve body is produced by co-operation with a pressure sensing element 32) which senses the difference between the hydraulic fluid pressure and the ambient pressure P_{AMB}. This is achieved by establishing pipe connections between the outlet port 11) and the port 34) in the valve housing, and a corresponding connection between a line connected to the reservoir 14) and the port 30).

In FIG. 5a), the pressure stabilizing valve is held in the closed position by the first valve body 27) being pressed against the seat 28). This valve body is displaceable in a narrow guide in a sleeve 25) which is arranged axially in the housing 24). The first valve body 27) thereby forms a displaceable end wall in the chamber VII. This chamber is supplied with driving fluid from the inlet 41) via a narrow channel 40), and can deliver driving fluid to the outlet 29) by displacing a second axially arranged valve body 36) away from a seat 37) which is arranged in the first valve body 27). This second valve body 36) is displaceable only a short distance away from the seat 37) before it hits the inside of the first valve body, so that a further displacement in the direction away from the seat 37) will cause the first valve body to be displaced away from the seat surface 28) and allows for fluid flow. When the second valve body 36) is close to the seat 37), the pressure in chamber VII will be P_{AMB}, and the first valve body 27) is pressed down against the seat surface 28) by the force from a spring 39) and by the pressure difference between the inlet 41) and the outlet 29).

Since the second valve body will typically has a diameter of size 40 mm, a considerable force will in principle be required to push the first valve body away from the seat 28). By pushing the second valve body away from the seat 37), it is opened for discharge of liquid from chamber VII to the outlet 29). The narrow channel 40) can only provide modest filling, and thereby the force which seeks to press the first valve body against the seat surface 28) can typically be reduced by 90%. This means that the regulation process becomes significantly more precise.

The pressure stabilizing valve is provided with a spring package 31) which defines the desired hydraulic pressure in relation to the ambient pressure. This spring package can typically be dimensioned so that the pressure sensing element is displaced 13 mm in the direction of the inlet 41) if sensed pressure drops 30 bar in relation to a desired pressure, whilst the first valve body typically can be dimensioned so that displacement of 13 mm changes the flow cross section from zero to an opening corresponding to Ø35. One can, for example, choose that the pressure stabilizing valve goes into a fully open position if the hydraulic pressure drops to 320 bar, and goes towards a completely closed position when the consumption drops so that the hydraulic pressure increases to 350 bar.

The valve device comprises a first 33), a second 35) and a third 26) sliding seal. The first sliding seal 33) is arranged to prevent leakage between the pressure sensing chamber VIII and chamber IX which maintains the pressure P_{AMB}. The second sliding seal 35) is arranged to prevent leakage between the pressure sensing chamber VIII and the outlet 29). The third sliding seal 26) is arranged to limit unwanted leakage into chamber VII.

### Maintaining Hydraulic Capacity

A hydraulic system according to the invention will normally be based on the use of a non-lubricating fluid which is used both as a propellant and as a hydraulic fluid, this fluid being recycled in a closed circuit. In a preferred embodiment, the hydraulic system is permanently pressurized, so that the hydraulic equipment in question can be activated by only opening a valve which is arranged between this equipment and the outlet port 11). Consequently, it is desirable that consumed hydraulic capacity can be recovered / maintained while the accumulator system is pressurized, and that the recovery process has the least possible effect on the hydraulic pressure that is generated.

A charging system according to the invention is based on hydraulic capacity being recovered by an interaction between two pump types, both of which are commercially available; An electrically driven subsea pump 22) designed to increase the pressure in non-lubricating liquids and an intensifier pump 42). The latter is preferably based on Norwegian patent 344418. The charging process is based on a position indicator (not shown) which is arranged to activate the charging system when one or more piston devices have been displaced a given distance due to consumption of some hydraulic capacity. The charging system must be deactivated when the indicators signal that the hydraulic system is back to full capacity. This type of feature is considered as known technology. Activation of the charging system means that the electrically driven pump starts by sucking liquid from the drive chamber via the pipe connecting the pressure stabilizing valve 20) to the inlet port 5), at the same time as the intensifier pump begins to push liquid back to the accumulator hydraulic chambers via the outlet port 11).

Only a modest increase in the pressure at the outlet port 11) is required for liquid to be forced back into the accumulator chambers, as will be achieved when the amount of liquid pumped out of the accumulator unit’s drive chambers is sufficiently large in relation to the amount of liquid that is available for being pushed into the hydraulic chambers. This is illustrated by the following calculation example;

The example is based on the accumulator units generating hydraulic power at a depth of 600 meters, and that they are configured with a gain factor of 7.8 (cf. Table 2). In this situation, chamber III acts as the hydraulic chamber. When the gain factor is set to 7.8, it means that 7.8 liters of liquid must be removed from the drive chamber for every liter of liquid that is forced back into chamber III. The charging function is based on that the liquid that is removed from the drive chamber by the electrically driven pump is being pressurized sufficiently to function as a driving medium for the intensifier pump, as we choose to base the charging system on an intensifier pump 42) with a gain factor of 8. This means that 8 liters liquid removed from the drive chamber may be used by the intensifier pump to increase the pressure of 1 liter of liquid taken up from the reservoir 14) via the inlet 46) to the extent that this liquid can be forced into chamber III via the outlet port 11). Under these conditions, 0.2 liters more liquid will be removed than what is needed for chamber III to receive 1 liter of liquid. Consequently, the pressure in the drive chamber will drop so that the pressure regulating valve opens and compensates for this volume.

A relevant type of electrically driven pump may typically have the capacity to pump 40 liters of liquid per minute. An intensifier pump with gain factor 8 will then be able to pump 5 liters of liquid per minute back to the accumulator units. We assume as an example that the pressure stabilizing valve is designed to maintain a hydraulic pressure of 345 bar. We further assume that the intensifier pump must generate a liquid pressure that is 15 bar higher - i.e. 360 bar - to push liquid back to the accumulator units. Since the intensifier pump has a gain factor of 8, it will then require an operating pressure of approximately 360 bar / 8 = 45 bar (above ambient water pressure). Based on Table 2 will the pressure compensating valve under the given conditions be designed to create a pressure drop ΔP = 18.7 bar * (61-51) / (86.9-51) = 5.2 bar. This means that the electrically driven pump will increase the pressure of the liquid that is sucked out of the drive chamber from approx. P_{AMB} - 5.2 bar to P_{AMB} + 45 bar. The charging system is self-regulating in the sense that it itself regulates the pressure to the intensifier pump inlet 44) to the level required to charge the accumulator units.

We then imagine that the hydraulic system are to be charged while it is located at a depth of 1500 meters. Based on Table 2, the accumulator unit should then be configured for a gain factor of 3.76. When the charging system is activated, the electrically driven pump will start pumping 40 liters per minute from the drive chambers, with the result that the intensifier pump charges the accumulator units at 5 liters per minute. In this situation, the amount that must be removed from the drive chambers will be 5 liters / min. * 3.76 = 18.8 liters / min. Since the electrically driven pump removes 40 liters / min, the pressure stabilizing valve in this situation will compensate for this by to provide liquid supply to the drive chambers of size 21.2 liters / min.

### Effect of Leakage in Sliding Seals

A hydraulic system according to the invention will have a certain liquid leakage into the pressureless chambers via the various sliding seals. This leakage will normally be small, and not to affect the capacity or function of the hydraulic system to any appreciable extent provided the accumulator units are not kept pressurized for a long time. However, it may be desirable to be able to remove liquid from these chambers. In FIG. 6 it is indicated that the accumulator units should be oriented so that any liquid in the virtually pressureless chambers is given the opportunity to flow down to a low-lying tank 23). This tank can be provided with a built-in, single-acting pump which can be activated by opening the valve 47) and pumping received liquid back to the reservoir 14). This can be solved in various ways using known techniques and will not be further described.

1-3. (canceled)

4. An underwater-based, depth-compensable accumulator system consisting of at least one accumulator unit in cooperation with a switching device, the accumulator unit comprising an axially displaceable piston device which delimits a number of chambers and which is adapted to producing a desired pressure of hydraulic fluid stored in the accumulator unit by utilizing the overpressure of a supplied propellant in relation to one or more substantially pressureless chambers in the accumulator unit, wherein
the accumulator unit consists of an accumulator housing with leak-free cylindrical guides for the piston device which comprises a hollow piston rod and two pistons which cooperate with a rod which is fixedly mounted in the accumulator housing and having a cylindrical outgrowth mounted on a sliding seal whereby the accumulator housing delimits up to 6 separate chambers with separate connections to ports arranged in the accumulator housing, in that three of the chambers have contact with pressure surfaces on the piston arrangement facing away from the inlet port so that pressurization of these chambers produces forces which seek to press the piston device in the direction of the inlet port, and the other chambers has contact with pressure surfaces facing away from the inlet port so that pressurization of these chambers produces forces which seek to push the piston arrangement in the direction away from the inlet port,
the largest pressure surface of the piston device faces chamber I, which during operation is permanently connected to pressurized drive medium via the inlet port,
at least one of the up to three separate chambers which are in contact with a pressure surface which is opposite to the largest pressure surface of the piston device, is arranged to be virtually without pressure, and
the switching device has an outlet port for discharging hydraulic fluid, and comprises solenoid-controlled, hydraulic or mechanically operated switching valves which are connected via the ports in the accumulator housing to each of the chambers so that it is possible to carry out a desired change with regard to which of the chambers are to be without pressure and which are connected respectively to the inlet port and respectively to the outlet port so as to be able to change the relationship between the pressure in the supplied drive medium and the pressure of the hydraulic fluid which is discharged via the outlet port.

5. A subsea-based accumulator system according to claim 4, wherein the propellant is supplied from a flexible reservoir containing liquid with approximate ambient pressure, and that a pressure stabilizing valve is arranged between the outlet of this reservoir and the inlet port which senses the pressure at the outlet port of the switching device and which is arranged to regulate the supply of drive medium to the accumulator units so that the hydraulic pressure at the outlet port is maintained at a fixed, pre-set level.

6. A subsea accumulator system according to claim 4, wherein the pressure stabilizing valve is arranged to control the supply of drive medium to the accumulator units by displacing an axially arranged first valve body relative to an annular seat surface and thus vary the flow cross-section of drive medium which is led from an inlet to an outlet in the valve housing, the displacement of the valve body being produced in cooperation with a pressure sensing element which senses the difference between hydraulic fluid pressure at the outlet port and the ambient water pressure, and which is biased towards the inlet of a spring so that the pressure sensing element has a defined position when sensed hydraulic pressure corresponds to the desired level, the valve device also comprising:
a sleeve which is arranged axially in the valve housing and which has a narrow inner guide for the first valve body so that a chamber emerges where this valve body constitutes a displaceable end wall, wherein this chamber is supplied with fluid from the inlet via a narrow channel arranged in the sleeve;
a second valve body which is limited axially displaceable relative to a seat arranged in the first valve body, so that a displacement of the second valve body away from the seat produces a leakage of liquid from chamber VII which causes the pressure in this chamber to drop to a fraction of the pressure at the inlet, and so that a further displacement of the second valve body in the same direction will displace the first valve body in same direction; and
a first and a second, and a third sliding seal in that
the first sliding seal is arranged to minimize leakage between the pressure sensing chamber VIII and chamber IX,
the second sliding seal is arranged to prevent leakage between the pressure sensing chamber VIII and the outlet, and
the third sliding seal is arranged to limit unwanted leakage into chamber VII.

7. A subsea accumulator system according to claim 5, wherein the pressure stabilizing valve is arranged to control the supply of drive medium to the accumulator units by displacing an axially arranged first valve body relative to an annular seat surface and thus vary the flow cross-section of drive medium which is led from an inlet to an outlet in the valve housing, the displacement of the valve body being produced in cooperation with a pressure sensing element which senses the difference between hydraulic fluid pressure at the outlet port and the ambient water pressure, and which is biased towards the inlet of a spring so that the pressure sensing element has a defined position when sensed hydraulic pressure corresponds to the desired level, the valve device also comprising;
a sleeve which is arranged axially in the valve housing and which has a narrow inner guide for the first valve body so that a chamber emerges where this valve body constitutes a displaceable end wall, wherein this chamber is supplied with fluid from the inlet via a narrow channel arranged in the sleeve;
a second valve body which is limited axially displaceable relative to a seat arranged in the first valve body, so that a displacement of the second valve body away from the seat produces a leakage of liquid from chamber VII which causes the pressure in this chamber to drop to a fraction of the pressure at the inlet, and so that a further displacement of the second valve body in the same direction will displace the first valve body in same direction; and
a first and a second, and a third sliding seal in that
the first sliding seal is arranged to minimize leakage between the pressure sensing chamber VIII and chamber IX,
the second sliding seal is arranged to prevent leakage between the pressure sensing chamber VIII and the outlet, and
the third sliding seal is arranged to limit unwanted leakage into chamber VII.
